(19) United States
(12) Patent Application Publication
(10) Pub. No.: US 2026/0057543 A1
(43) Pub. Date: Feb. 26, 2026

(54) INFORMATION PROCESSING APPARATUS, INFORMATION PROCESSING METHOD, AND COMPUTER-READABLE MEDIUM

(71) Applicant: Panasonic Automotive Systems Co., Ltd., Kanagawa (JP)

(72) Inventors: Atsushi HIRAI, Tokyo To (JP); Takashi HATANO, Kanagawa Ken (JP)

(73) Assignee: Panasonic Automotive Systems Co., Ltd., Kanagawa (JP)

(21) Appl. No.: 19/302,847

(22) Filed: Aug. 18, 2025

(30) Foreign Application Priority Data
Aug. 21, 2024 (JP) 2024-139996

(51) Int. Cl. G06T 7/73

(52) U.S. Cl. CPC G06T 7/73; G06T 2207/30196

(57) ABSTRACT

An information processing apparatus according to an aspect of the present disclosure includes a memory in which a program is stored, and a processor coupled to the memory and configured to perform processing by executing the program. The processing including: acquiring an image captured by a camera and including a fingertip with which a user points to a target; calculating three-dimensional coordinates of the fingertip at a camera viewpoint from the image; transforming the three-dimensional coordinates of the fingertip at the camera viewpoint into three-dimensional coordinates of the fingertip at a viewpoint different from the camera viewpoint; and calculating an angle at which the fingertip points to the target, based on two-dimensional coordinates of the fingertip excluding a depth direction identified from the three-dimensional coordinates of the fingertip at the different viewpoint.

### CROSS-REFERENCE TO RELATED APPLICATIONS

This application is based upon and claims the benefit of priority from Japanese Patent Application No. 2024-139996, filed on Aug. 21, 2024, the entire contents of which are incorporated herein by reference.

### FIELD

The present disclosure relates to an information processing apparatus, an information processing method, and a computer readable medium.

### BACKGROUND

Conventionally, there are various devices that detect a movement of a user's hand and control an operation according to the detected movement of the hand (see, for example, JP 2024-34419 A). For example, concerning an operation target such as a display that a user's hand cannot reach or an operation device with which a user in a vehicle points to an object outside the vehicle, there is an apparatus that changes the content displayed on the operation device according to a movement of a user's hand without the user having to directly touch the operation device.

In a technique as described above, for example, the user may need to change the posture of the user in order to perform an input operation on the display, or the user may lack intuition in the switch operation, that is, it is difficult to perform the operation.

The present disclosure provides an information processing apparatus, an information processing method, and a computer-readable medium capable of improving user operability.

### SUMMARY

An information processing apparatus according to an aspect of the present disclosure includes a memory in which a program is stored, and a processor coupled to the memory and configured to perform processing by executing the program. The processing including: acquiring an image captured by a camera and including a fingertip with which a user points to a target; calculating three-dimensional coordinates of the fingertip at a camera viewpoint from the image; transforming the three-dimensional coordinates of the fingertip at the camera viewpoint into three-dimensional coordinates of the fingertip at a viewpoint different from the camera viewpoint; and calculating an angle at which the fingertip points to the target, based on two-dimensional coordinates of the fingertip excluding a depth direction identified from the three-dimensional coordinates of the fingertip at the different viewpoint.

### BRIEF DESCRIPTION OF THE DRAWINGS

FIG. 1 is a schematic diagram illustrating an example of an information processing apparatus;

FIG. 2 is a schematic diagram for explaining processing performed by an information processing apparatus according to a first comparative example;

FIG. 3 is a schematic diagram for explaining the processing performed by the information processing apparatus according to the first comparative example;

FIG. 4 is a diagram illustrating a schematic configuration of an information system including a control device that is an information processing apparatus according to a first embodiment;

FIG. 5 is a schematic diagram for explaining processing performed by the control device according to the first embodiment;

FIG. 6 is a schematic diagram for explaining the processing performed by the control device according to the first embodiment;

FIG. 7 is a flowchart illustrating a processing procedure of the control device according to the first embodiment;

FIG. 8 is a schematic diagram for explaining processing performed by a control device according to a first modification;

FIG. 9 is a schematic diagram for explaining processing performed by an information processing apparatus according to a second modification;

FIG. 10 is a schematic diagram for explaining the processing performed by the information processing apparatus according to the second modification;

FIG. 11 is a diagram illustrating a schematic configuration of an information system including a control device that is an information processing apparatus according to the second embodiment;

FIG. 12 is a schematic diagram for explaining the processing performed by the control device according to the second embodiment;

FIG. 13 is a flowchart illustrating a processing procedure of the control device according to the second embodiment;

FIG. 14 is a schematic diagram for explaining processing performed by a control device according to a third modification;

FIG. 15 is a schematic diagram for explaining the processing performed by the control device according to the third modification;

FIG. 16 is a schematic diagram for explaining processing performed by an information processing apparatus according to a second comparative example;

FIG. 17 is a diagram illustrating a schematic configuration of an information system including a control device that is an information processing apparatus according to the third embodiment;

FIG. 18 is a schematic diagram illustrating an example of second correction coefficient information according to the third embodiment;

FIG. 19 is a diagram illustrating a schematic configuration of an information system including a control device that is an information processing apparatus according to a fourth embodiment;

FIG. 20 is a schematic diagram for explaining processing performed by an information processing apparatus according to the fourth embodiment; and

FIG. 21 is a flowchart illustrating a processing procedure of the control device according to the fourth embodiment.

### DETAILED DESCRIPTION

Hereinafter, an embodiment of an information processing apparatus according to the present disclosure will be described with reference to the drawings.

### First Embodiment

Before describing an information processing apparatus according to the first embodiment, an apparatus that operates based on a movement of a user's hand will be described.

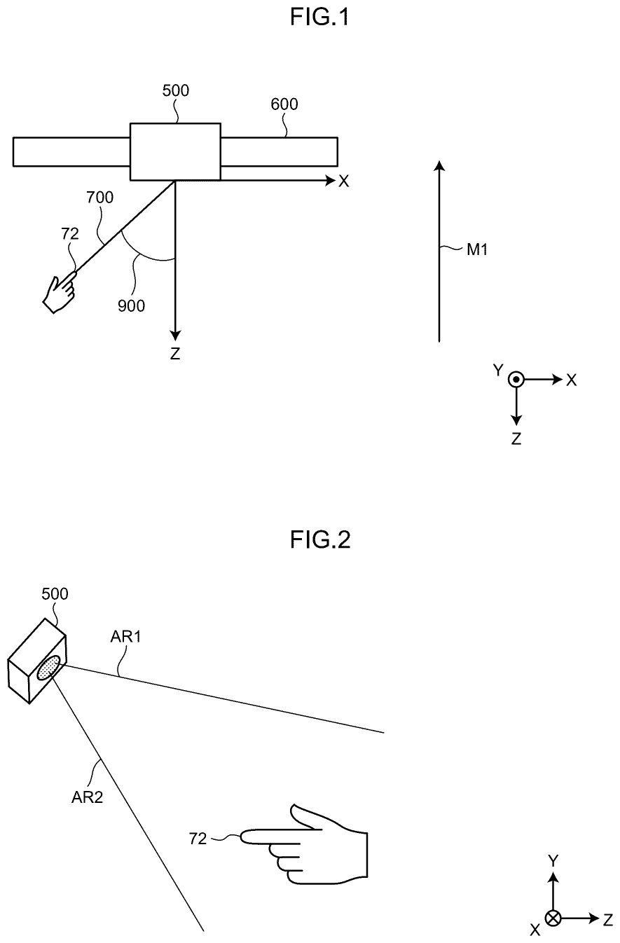

FIG. 1 is a schematic diagram illustrating an example of an information processing apparatus. FIG. 1 illustrates an example of an information processing apparatus that operates based on a movement of a user's hand. The information processing apparatus includes a sensor 500 and an operation device 600. The sensor 500 is, for example, a camera. The sensor 500 captures an image of a user who is an operator. The user has an arm. Here, the arm includes not only an upper arm and a forearm but also a hand. The hand also includes a fingertip 72. The fingertip 72 is, for example, a first joint of a finger. The operation device 600 is, for example, a display device such as a display mounted on a vehicle. The information processing apparatus controls data displayed by the operation device 600 based on a position of the user's fingertip 72.

Furthermore, for example, in a case where the user points to a building outside the vehicle from the interior of the vehicle, the information processing apparatus controls the operation device 600 to display a direction in which the user points to the target based on the position of the user's fingertip 72. The target pointed to by the user's fingertip 72 includes the operation device 600 or an object such as a building outside the vehicle.

In addition, the information processing apparatus calculates an angle for receiving an operation on the device. Specifically, the information processing apparatus calculates an angle 900 indicating an angle formed between a traveling direction M1 of the vehicle and an angular line 700 along which the user's fingertip 72 points to the operation device 600 on the XZ-axis plane.

In FIG. 1 and the drawings relating to the operation device 600 to be described below, an X axis, a Y axis, and a Z axis orthogonal to each other refer to a left-right direction, an up-down direction, and a front-rear direction of the operation device 600, respectively. In the following description, when an X direction, a Y direction, or a Z direction are simply mentioned, it refers to each axial direction and includes two opposite directions.

In addition, when the positive direction of the X axis is specified, it is one direction from the left side to the right side, when the positive direction of the Y axis is specified, it is one direction from the lower side to the upper side, and when the positive direction of the Z axis is specified, it is one direction from the front side to the rear side. When the negative direction of the X axis is specified, it is one direction from the right side to the left side, when the negative direction of the Y axis is specified, it is one direction from the upper side to the lower side, and when the negative direction of the Z axis is specified, it is one direction from the rear side to the front side.

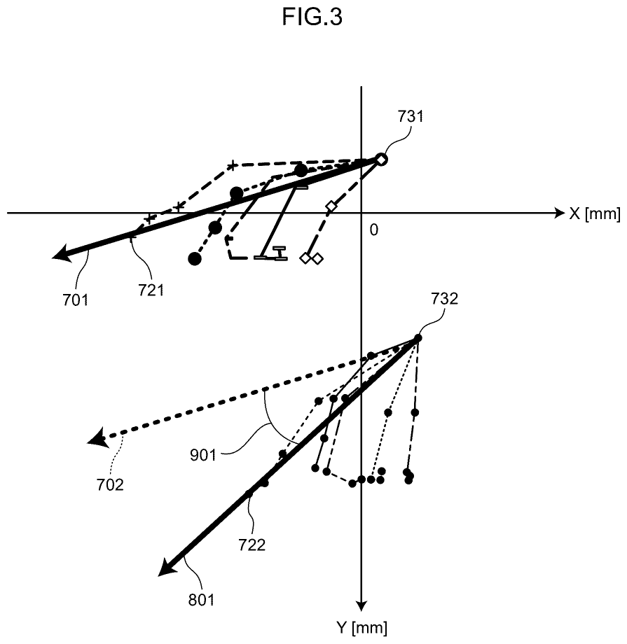

FIGS. 2 and 3 are schematic diagrams for explaining processing performed by an information processing apparatus according to a first comparative example. FIG. 2 illustrates a sensor 500 mounted on a vehicle and a user's fingertip 72. When the user's fingertip 72 is used as a base point, the sensor 500 is mounted on the vehicle so as to be located in the positive direction of the Y axis and the negative direction of the Z axis on the YZ-axis plane. The sensor 500 captures an image of a movement of the user's fingertip 72 in an imaging region at an angle of view between a first angle AR1 and a second angle AR2.

FIG. 3 illustrates a result of extracting feature points of a user's hand in the image captured by the sensor 500. The feature points of the user's hand are joints of the user's five fingers and wrist. Here, it is assumed that user's fingertip 721 and fingertip 722 are both pointing to the operation device 600 at the same azimuth angle. A user's wrist 731 is located in the negative direction of the X axis and in the negative direction of the Y axis with respect to a user's wrist 732.

An arrow 701 illustrated in FIG. 3 is an angular line including a straight line connecting the user's fingertip 721 and the user's wrist 731 as a base point. An arrow 801 is an angular line including a straight line connecting the user's fingertip 722 with the user's wrist 732 as a base point. An arrow 702 is an angular line obtained by translating the arrow 701 with the user's wrist 732 as a base point.

Here, when comparing the arrow 702 and the arrow 801, a difference angle 901 occurs even though the user is pointing at the same azimuth angle. The difference angle 901 occurs because the inclination of the posture of the sensor 500 and the positional relationship between the sensor 500 and the user's hand are not considered. Specifically, the difference angle 901 occurs because the sensor 500 mounted on the vehicle so as to be located in the negative direction of the Z axis with the user's fingertip 72 as a base point images the user's fingertip 72, and the information processing apparatus identifies the user's hand from the image captured by the sensor 500 and calculates the angle on the XZ-axis plane.

As a result, the user may feel difficult to operate the operation device 600 because different directions are indicated even though the user is pointing to the operation device at the same azimuth angle. Therefore, the present embodiment provides an information processing apparatus capable of improving user operability, for example, in a case where the sensor 500 is located in the positive direction of the Y axis and in the negative direction of the Z axis with the user's fingertip 72 as a base point.

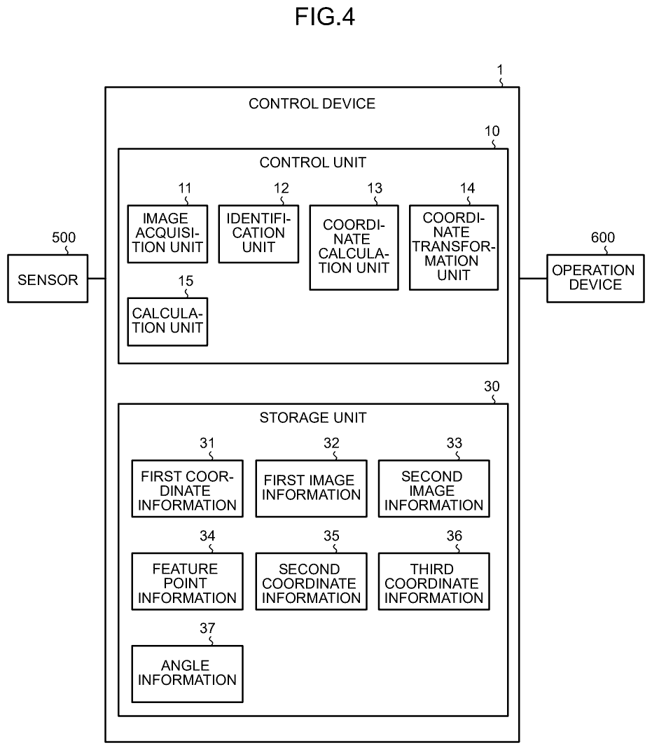

FIG. 4 is a diagram illustrating a schematic configuration of an information system including a control device that is an information processing apparatus according to the first embodiment. The information processing apparatus according to the first embodiment includes a sensor 500, an operation device 600, and a control device 1.

The sensor 500 is, for example, a camera device. As an example, the sensor 500 is a visible light camera. The sensor 500 captures an image of a user who is an operator, and outputs the captured image to the control device 1. The sensor 500 is an example of an imaging unit. The sensor 500 continuously executes imaging processing, and outputs an image to the control device 1. The sensor 500 is mounted in the interior of the vehicle, and is located, for example, in front of the user, and in the positive direction of the Y axis and in the negative direction of the Z axis on the YZ-axis plane. That is, the sensor 500 is positioned obliquely above the user. The operation device 600 is a display unit that displays various types of data. The operation device 600 is, for example, a display device such as a display mounted on the vehicle.

The control device 1 executes processing of data displayed on the operation device 600 according to a movement of the user's fingertip 72 detected via the sensor 500.

The control device 1 includes a control unit 10 and a storage unit 30. The control unit 10 is constituted by, for example, a central processing unit (CPU), and integrally controls an operation of each unit of the control device 1.

The control device 1 according to the present embodiment includes a ROM and a RAM (not illustrated). The ROM stores various programs. The RAM is a work area used by the CPU when executing the programs. The control device 1 includes, for example, a processor and a memory, and the processor executes a program stored in the memory, thereby realizing the control unit 10 and the functions of the functional blocks included in the control unit 10. The CPU is an example of the processor. The storage unit 30 is an example of the memory.

The CPU executes the programs stored in the ROM by using the RAM as a work area, thereby realizing an image acquisition unit 11, an identification unit 12, a coordinate calculation unit 13, a coordinate transformation unit 14, and a calculation unit 15 as illustrated in FIG. 4. This may be rephased as the control device 1 including the image acquisition unit 11, the identification unit 12, the coordinate calculation unit 13, the coordinate transformation unit 14, and the calculation unit 15. The image acquisition unit 11, the identification unit 12, the coordinate calculation unit 13, the coordinate transformation unit 14, and the calculation unit 15 may be realized by different hardware components.

The image acquisition unit 11 acquires an image obtained by imaging the user from the sensor 500. Furthermore, the image acquisition unit 11 acquires an image including the fingertip 72 with which the user is pointing to a target from the acquired image in which the user is imaged.

The identification unit 12 identifies feature points corresponding to the fingertip 72 from the image including the fingertip 72 with which the user is pointing to the target. Specifically, the identification unit 12 identifies feature points corresponding to the fingertip 72 from the image including the fingertip 72 with which the user is pointing to the target and acquired by the image acquisition unit 11. Here, the feature points corresponding to the fingertip 72 are joints of the fingertip 72 of the user's hand and the user's wrist. The identification unit 12 identifies feature points corresponding to joints of the fingers of the user's hand and the user's wrist from the image including the fingertip 72 pointing to the target using a known method.

The coordinate calculation unit 13 calculates three-dimensional coordinates of the fingertip 72 at a camera viewpoint from the image including the fingertip 72 with which the user is pointing to the target. Specifically, the coordinate calculation unit 13 calculates three-dimensional coordinates of the fingertip 72 at the camera viewpoint based on the feature points corresponding to the joints of the user's hand and the user's wrist identified by the identification unit 12 from the image including the fingertip 72 with which the user is pointing to the target.

For example, the coordinate calculation unit 13 calculates three-dimensional coordinates of the feature points corresponding to the joints of the user's hand and the user's wrist in the coordinate system, based on coordinate positions on the X axis and the Y axis in the pixel coordinate system for the image including the fingertip with which the user is pointing to the target and the distance to the fingertip 72 in the depth direction of the sensor 500 set in advance. The depth direction of the sensor 500 is, for example, a direction connecting a camera installed in the vehicle and a position of the predetermined fingertip 72. That is, the depth direction of the sensor 500 is a direction of the fingertip 72 located in the negative direction of the Y axis and in the positive direction of the Z axis in a case where the camera installed in the vehicle is used as a base point on the YZ-axis plane.

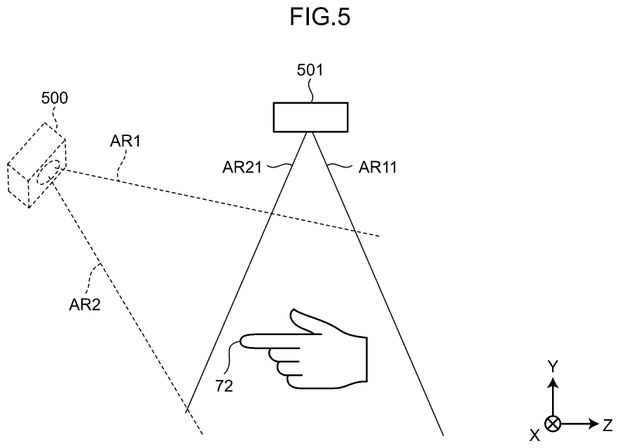

The coordinate transformation unit 14 transforms the three-dimensional coordinates of the fingertip 72 at the camera viewpoint into three-dimensional coordinates of the fingertip 72 at a viewpoint different from the camera viewpoint. Specifically, the coordinate transformation unit 14 transforms the three-dimensional coordinates of the fingertip 72 at the camera viewpoint calculated by the coordinate calculation unit 13 into three-dimensional coordinates of the fingertip 72 at a viewpoint different from the camera viewpoint. Here, the processing in which the coordinate transformation unit 14 performs coordinate transformation will be described with reference to FIG. 5.

FIG. 5 is a schematic diagram illustrating the processing of the control device 1 according to the first embodiment. FIG. 5 illustrates the sensor 500 mounted on the vehicle illustrated in FIG. 2 and a viewpoint 501 different from the sensor 500. The viewpoint 501 is a viewpoint when the coordinate of the sensor 500 on the Z axis is translated and orthogonal to the ground surface, and the user's fingertip 72 is viewed from directly above the vehicle. That is, in a case where the user's fingertip 72 is used as a base point, it is assumed that the viewpoint 501 is mounted on the vehicle in the positive direction of the Y axis and directly below the vehicle. The viewpoint 501 is in a state in which a movement of the user's fingertip 72 is imaged in an imaging region at an angle of view between a third angle AR11 and a fourth angle AR21.

As illustrated in FIG. 5, for example, the coordinate transformation unit 14 transforms the three-dimensional coordinates of the fingertip 72 at the viewpoint of the sensor 500 calculated by the coordinate calculation unit 13 into three-dimensional coordinates of the fingertip 72 at the viewpoint 501 different from the viewpoint of the sensor 500 using a homogeneous transformation matrix.

Referring back to FIG. 4, the description will be continued. The calculation unit 15 calculates an angle at which the fingertip 72 points to the target based on two-dimensional coordinates of the fingertip 72 excluding the depth direction identified from the three-dimensional coordinates of the fingertip 72 at the different viewpoint 501. Specifically, the calculation unit 15 calculates an angle at which the fingertip 72 points to the target based on two-dimensional coordinates of the fingertip 72 excluding the depth direction identified from the three-dimensional coordinates of the fingertip 72 at the different viewpoint 501 transformed by the coordinate transformation unit 14.

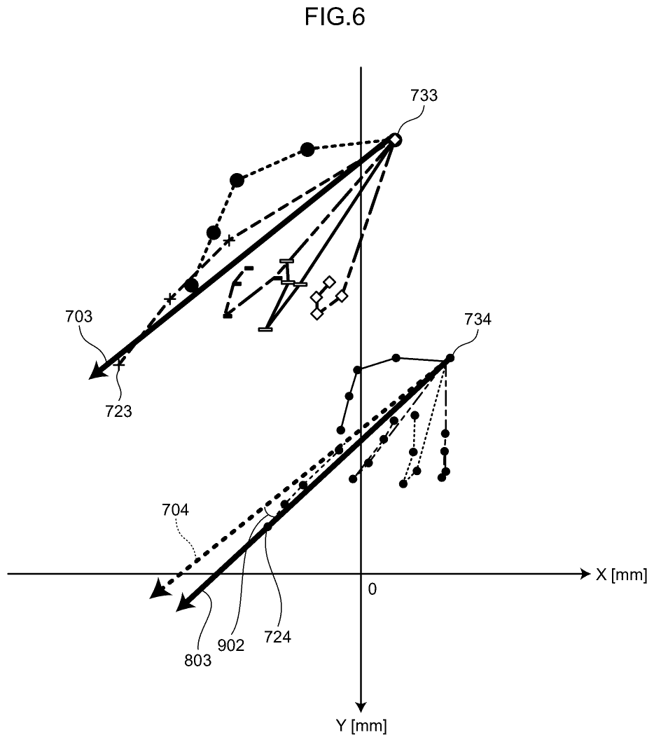

Here, a result of the processing performed by the calculation unit 15 will be described with reference to FIG. 6.

FIG. 6 is a schematic diagram for explaining the processing of the control device according to the first embodiment. FIG. 6 illustrates a result of the processing performed by the calculation unit 15. Here, it is assumed that user's fingertip 723 and fingertip 724 are both pointing to the operation device 600 at the same azimuth angle. A user's wrist 733 is located in the negative direction of the X axis and in the negative direction of the Y axis with respect to a user's wrist 734. Note that it is assumed that the user's fingertip 723 is located at the same position as the user's fingertip 721 illustrated in FIG. 3 described above. Similarly, it is assumed that the user's fingertip 724 is located at the same position as the user's fingertip 722 illustrated in FIG. 3 described above.

An arrow 703 illustrated in FIG. 6 is an angular line including a straight line connecting the fingertip 723 of the user's left hand to the user's wrist 733 as a base point. An arrow 803 is an angular line including a straight line connecting the fingertip 724 of the user's left hand to the user's wrist 734 as a base point. An arrow 704 is an angular line obtained by translating the arrow 703 with the user's wrist 734 as a base point.

Here, when comparing the arrow 704 and the arrow 803, a difference angle 902 occurs even though the user is pointing at the same azimuth angle. However, when the difference angle 902 illustrated in FIG. 6 is compared with the difference angle 901 illustrated in FIG. 3, the difference angle 902 is smaller than the difference angle 901 illustrated in FIG. 3, and the magnitude of the difference is reduced.

The reason why the magnitude of the difference is reduced is that the inclination of the posture of the sensor 500 and the positional relationship between the sensor 500 and the user's hand are not considered. Specifically, this is because the calculation unit 15 calculates an angle at which the fingertip 72 points to the target based on the two-dimensional coordinates of the fingertip 72 excluding the depth direction based on the coordinates obtained by the coordinate transformation unit 14 transforming the three-dimensional coordinates of the fingertip 72 at the viewpoint of the sensor 500 into the three-dimensional coordinates of the fingertip 72 at a viewpoint that is different from the sensor 500, and when the user's fingertip 72 is viewed from directly above in the vehicle orthogonally to the ground surface.

As a result, for example, even in a case where the operator points to the operation device 600 at the same azimuth angle but the position of the wrist is different, an angle calculated by the control device 1 can be made to point to the operation device 600 at the same azimuth angle, thereby improving user operability.

Referring back to FIG. 4, the description will be continued. The storage unit 30 stores various types of information. The storage unit 30 is realized by hardware for storing information (in other words, data), such as a memory or a storage. Specifically, the storage unit 30 stores first coordinate information 31, first image information 32, second image information 33, feature point information 34, second coordinate information 35, third coordinate information 36, and angle information 37.

The first coordinate information 31 includes three-dimensional coordinates of a position at which the sensor 500 is installed, information on an angle at which the sensor 500 is attached, three-dimensional coordinates of a position of the operation device 600, and the like. The first image information 32 information including an image obtained by imaging the user from the sensor 500. The second image information 33 information including an image including the fingertip 72 with which the user is pointing to a target and acquired by the control device 1. The first image information 32 and the second image information 33 include dates and times when the images are captured by the sensor 500.

The feature point information 34 is information including feature points corresponding to the fingertip 72 identified by the control device 1. The second coordinate information 35 is information including three-dimensional coordinates of the fingertip 72 at the camera viewpoint calculated by the control device 1. The third coordinate information 36 is information including three-dimensional coordinates of the fingertip 72 at the viewpoint 501 different from the camera viewpoint obtained by the control device 1 transforming the three-dimensional coordinates of the fingertip 72 at the camera viewpoint. The angle information 37 is information including an angle at which the fingertip 72 points to the target, the angle being calculated by the control device 1.

Here, the coordinate system in the first coordinate information 31 is an absolute coordinate system. The coordinate system in the feature point information 34 and the second coordinate information 35 is a pixel coordinate system of the sensor 500. The third coordinate information 36 and angle information 37 are relative coordinates based on the sensor 500 when the fingertip 72 is viewed at the different viewpoint 501 directly above the vehicle.

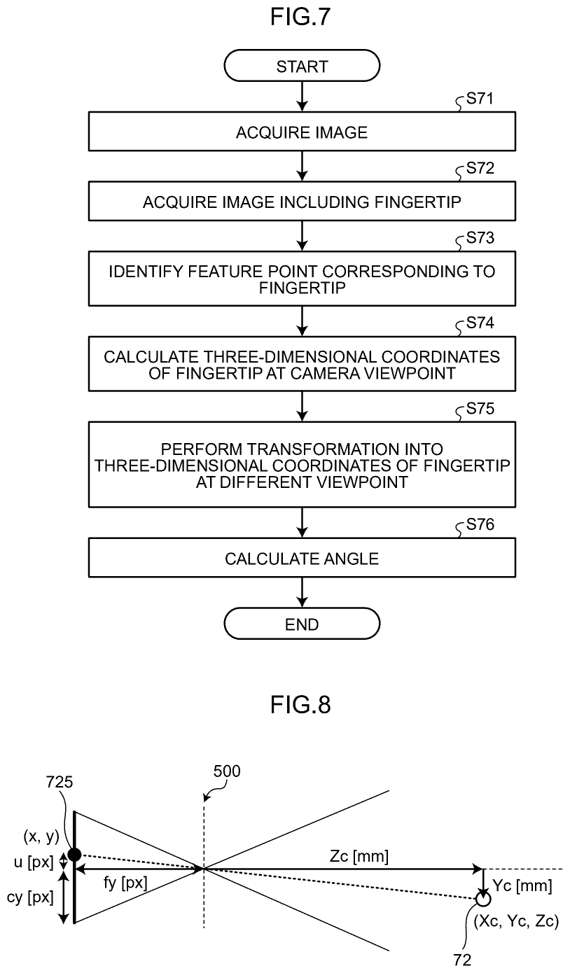

Next, a processing procedure of the control device 1 according to the first embodiment will be described with reference to FIG. 7. FIG. 7 is a flowchart illustrating a processing procedure of the control device 1 according to the first embodiment. Note that, concerning this processing, a flow of processing of calculating an angle at which the user's fingertip 72 points to a target will be described.

First, the image acquisition unit 11 acquires an image obtained by imaging the user from the sensor 500 (step S71). Then, the image acquisition unit 11 acquires an image including the fingertip 72 with which the user is pointing to a target from the acquired image in which the user is imaged (step S72). Subsequently, the identification unit 12 identifies a feature point corresponding to the fingertip 72 from the image including the fingertip 72 with which the user is pointing to the target and acquired by the image acquisition unit 11 (step S73).

Subsequently, the coordinate calculation unit 13 calculates three-dimensional coordinates of the fingertip 72 at the camera viewpoint based on the feature points corresponding to the joints of the user's hand and the user's wrist identified by the identification unit 12 from the image including the fingertip 72 with which the user is pointing to the target (step S74). The coordinate transformation unit 14 transforms the three-dimensional coordinates of the fingertip 72 at the camera viewpoint calculated by the coordinate calculation unit 13 into three-dimensional coordinates of the fingertip 72 at a viewpoint 501 different from the camera viewpoint (step S75).

Subsequently, the calculation unit 15 calculates an angle at which the fingertip 72 points to the target based on two-dimensional coordinates of the fingertip 72 excluding the depth direction identified from the three-dimensional coordinates of the fingertip 72 at the different viewpoint 501 transformed by the coordinate transformation unit 14 (step S76). When the processing of step S76 ends, this processing executed by the control device 1 ends.

As described above, the control device 1 according to one aspect of the present disclosure acquires an image captured by the camera and including a fingertip with which the user is pointing to a target. In addition, the control device 1 calculates three-dimensional coordinates of the fingertip 72 at a camera viewpoint from the image. In addition, the control device 1 transforms the three-dimensional coordinates of the fingertip at the camera viewpoint into three-dimensional coordinates of the fingertip 72 at a viewpoint 501 different from the camera viewpoint. Then, the control device 1 calculates an angle at which the fingertip 72 points to the target based on two-dimensional coordinates of the fingertip 72 excluding the depth direction identified from the three-dimensional coordinates of the fingertip 72 at the different viewpoint 501.

As a result, for example, even in a case where the camera is positioned obliquely above the user, the control device 1 can enable the user to operate the display without changing the posture of the user, by calculating the angle at which the fingertip 72 points to the target based on the two-dimensional coordinates of the fingertip 72 excluding the depth direction identified from the three-dimensional coordinates of the fingertip 72 at the viewpoint 501 different from the camera viewpoint. Therefore, the control device 1 can improve user operability.

Note that the above-described embodiment can be appropriately modified by changing a part of the configuration or function of each of the above-described devices. Therefore, some modifications of the above-described embodiment will be described below as other embodiments. Note that points different from the above-described embodiment will be mainly described below, and detailed description of points common to what have already been described above will be omitted.

### First Modification

In the above-described embodiment, a mode in which there is one operation device 600 has been described. In the first modification, a mode in which the coordinate calculation unit 13 of the control unit 10 of the control device 1 calculates three-dimensional coordinates in consideration of a focal length of the sensor 500 will be described. For example, the coordinate calculation unit 13 according to the first modification calculates three-dimensional coordinates of the fingertip 72 in the world coordinate system with the sensor 500 as the origin, using a focal length parameter of the sensor 500 and a distance in the depth direction between the sensor 500 and the hand, based on the feature points corresponding to the joints of the user's hand and the user's wrist identified by the identification unit 12 from the image including the fingertip 72 with which the user is pointing to the target.

FIG. 8 is a schematic diagram for explaining the processing of the control device according to the first modification. The schematic diagram illustrated in FIG. 8 is a diagram of an image viewed from the side. FIG. 8 illustrates the sensor 500, the user's fingertip 72, and the fingertip 725 included in the image of the user's fingertip 72 captured by the sensor 500. In the example of FIG. 8, the distance from the sensor 500 to the fingertip 72 is denoted by Zc (mm), and the distance from the fingertip 72 to the user's wrist is denoted by Yc (mm). Note that Zc is a fixed value and can be arbitrarily set. Furthermore, the focal length from the focal point of the sensor 500 to the image is denoted by fy (px), and the distance between the fingertip 725 and the user's wrist on the image is denoted by u (px). Here, the focal length fy (px) is also referred to as a focal length parameter of the sensor 500.

As a result, two similar triangles can be obtained, and u=fy×Yc/Zc can be obtained from the similarity relationship of u:fy=Yc:Zc. By calculating the distance u to the user's wrist, when the value of the optical center of the sensor 500 is denoted by cy (px), the coordinate y of the fingertip 72 on the Y axis can be calculated as y=u+cy=fy×Yc/Zc+cy.

Similarly, when the distance between the fingertip 725 and the user's wrist on the image is denoted by v (px), and the value of the optical center of the sensor 500 is denoted by cx (px), the coordinate x of the fingertip 72 on the X axis can be calculated as x=v+cy=fx×Yc/Zc+cx. Since the user is seated on a seat in the vehicle, the position of the user is substantially at a fixed position. Therefore, the control device 1 can calculate absolute coordinates with the sensor 500 as the origin by setting Zc between the sensor 500 and the hand as a fixed value.

### Second Modification

In the embodiment described above, a mode in which the sensor 500 is in front of the user has been described. However, the sensor 500 mounted on the vehicle may be attached other than in front of the user, for example, behind or beside the user. Therefore, in the second modification, a mode in which the sensor 500 is located other than in front of the user will be described.

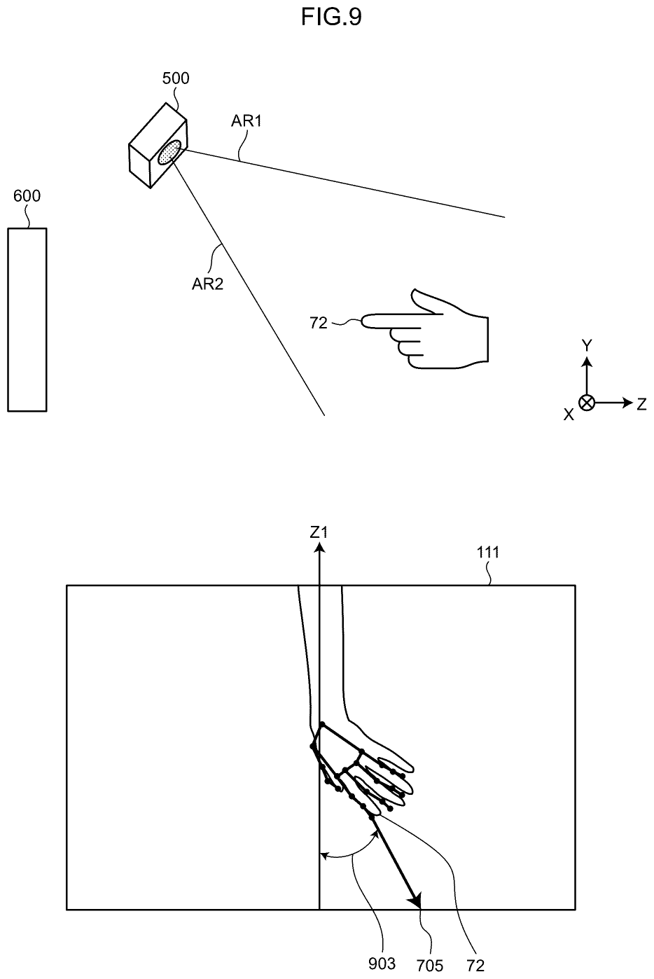

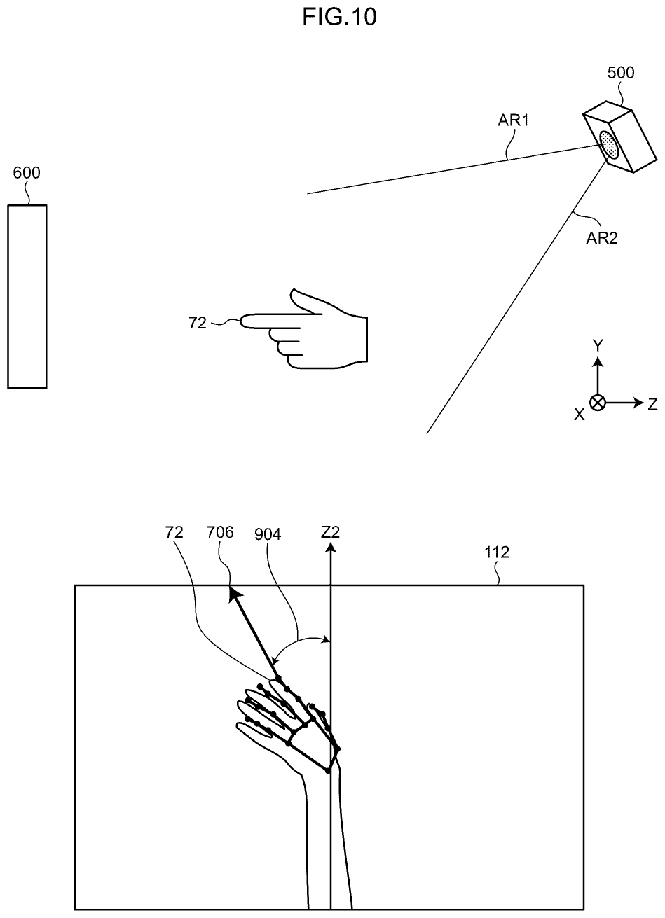

FIGS. 9 and 10 are schematic diagrams for explaining processing of the information processing apparatus according to the second modification. In FIG. 9, for example, it is assumed that the sensor 500 is positioned in front of the user's fingertip 72, and an image 111 captured by the sensor 500 is illustrated. In FIG. 10, for example, it is assumed that the sensor 500 is positioned behind the user's fingertip 72, and an image 111 captured by the sensor 500 is illustrated. Furthermore, it is assumed that the user's fingertips 72 illustrated in FIGS. 9 and 10 point to the operation device 600 at the same azimuth angle.

The direction of the user's fingertip 72 illustrated in FIG. 9 is indicated by an arrow 705. An arrow Z1 illustrated in FIG. 9 is a viewpoint in the depth direction of the sensor 500. The direction of the user's fingertip 72 illustrated in FIG. 10 is indicated by an arrow 706. An arrow Z2 illustrated in FIG. 10 is a viewpoint in the depth direction of the sensor 500.

Here, an angle 903 formed by the arrow 705 and the arrow Z1 illustrated in FIG. 9 and an angle 904 formed by the arrow 706 and the arrow Z2 illustrated in FIG. 10 are different although the user's fingertips 72 point to the operation device 600 at the same azimuth angle. This is because the image 111 in FIG. 9 and an image 112 in FIG. 10 are different from each other in the position at which the sensor 500 is attached to the vehicle.

However, the control device 1 calculates three-dimensional coordinates of the fingertip 72 at the camera viewpoint from the image, and transforms the three-dimensional coordinates of fingertip at the camera viewpoint into three-dimensional coordinates of the fingertip 72 at a viewpoint 501 different from the camera viewpoint. In addition, the control device 1 calculates an angle at which the fingertip 72 points to the target based on two-dimensional coordinates of the fingertip 72 excluding the depth direction identified from the three-dimensional coordinates of the fingertip 72 at the different viewpoint 501, enabling the user to operate the display without changing the posture of the user. Therefore, the control device 1 can improve user operability.

### Second Embodiment

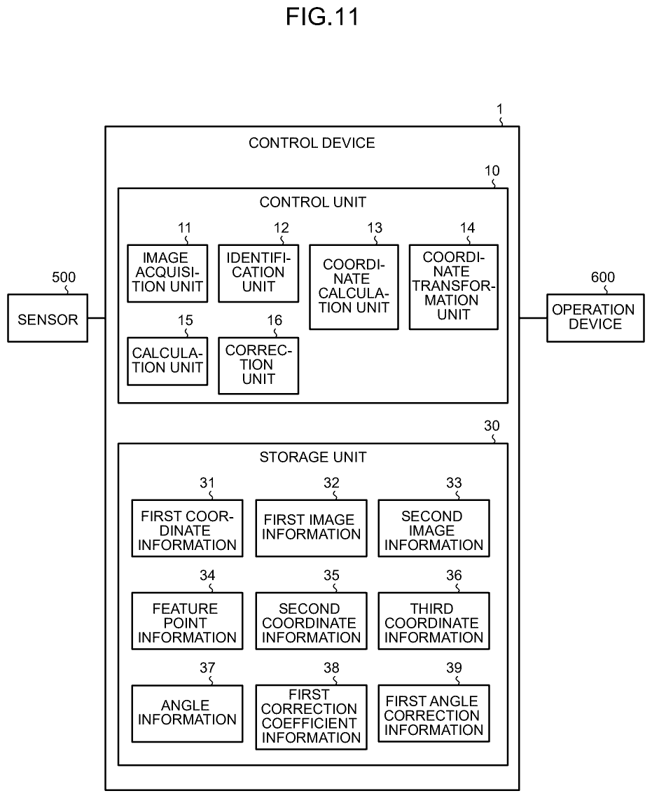

Next, in the second embodiment, processing of calculating an angle in a change according to a vertical movement of the user's fingertip 72 will be described. FIG. 11 is a diagram illustrating a schematic configuration of an information system including a control device 1 that is an information processing apparatus according to the second embodiment. The information processing apparatus according to the second embodiment further realizes a correction unit 16 of the control unit 10 of the control device 1, and first correction coefficient information 38 and first angle correction information 39 of the storage unit 30 of the control device 1, as compared with the information processing apparatus according to the first embodiment.

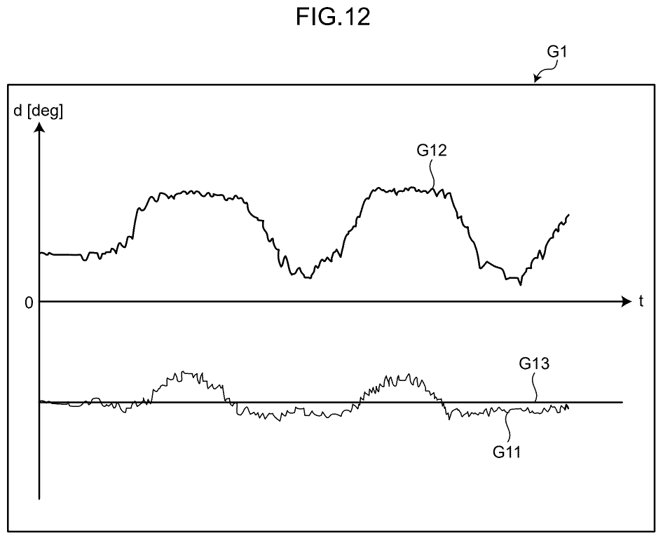

FIG. 12 is a schematic diagram for explaining the processing of the control device 1 according to the second embodiment. In a schematic diagram G1 that is a graph illustrated in FIG. 12, the vertical axis represents an angle d (deg), and the horizontal axis represents t (sec). Here, it is assumed that the user's fingertip 72 points to the operation device 600 at the same azimuth angle.

A graph G11 in FIG. 12 indicates an angle of a movement of the user's fingertip 72 in the left-right direction. Here, looking at the graph G11, the value of the angle in the graph G11 fluctuates up and down even though the user's fingertip 72 points to the operation device 600 at the same azimuth angle. This is because an error occurs due to a change according to a vertical movement of the user's fingertip 72.

Therefore, the correction unit 16 corrects the angle to a first correction angle according to the movement of the fingertip 72 in consideration of the depth direction of the sensor 500. Specifically, the correction unit 16 corrects the angle calculated by the calculation unit 15 to the first correction angle according to the movement of the fingertip 72 in consideration of the depth direction of the sensor 500.

For example, the correction unit 16 calculates a movement in the up-down direction corresponding to the two-dimensional coordinates in the left-right direction of the fingertip 72 excluding the depth direction from the three-dimensional coordinates of the fingertip 72 at the different viewpoint 501, and calculates a vertical angle corresponding to the horizontal angle calculated by the calculation unit 15. Here, the calculated vertical angle is an angle in a movement of the user's fingertip 72 in the vertical direction or the upward direction, which is positive, for example, in a graph G12 in FIG. 12.

In addition, the correction unit 16 generates first correction coefficient information indicating a coefficient of a correction value corresponding to the vertical angle, and stores the first correction coefficient information in the storage unit 30. The coefficient of the correction value corresponding to the vertical angle is, for example, a value that makes the value of the horizontal angle constant. Here, the first correction coefficient information is a table or the like in which the horizontal angle, the vertical angle, and the correction value calculated by the calculation unit 15 are associated with each other.

Then, the correction unit 16 corrects the angle calculated by the calculation unit 15 to a first correction angle based on the first correction coefficient information. A graph G13 in FIG. 12 is an angle obtained by correcting the graph G11. Here, for example, as illustrated in the graph G13 in FIG. 12, the correction unit 16 corrects the angle to the first correction angle from the graph G11. As a result, the control device 1 can suppress an error due to a change according to a vertical movement of the user's fingertip 72.

Referring back to FIG. 11, the description will be continued. The first correction coefficient information 38 is information including the coefficient of the correction value corresponding to the vertical angle generated by the control device 1. The first angle correction information 39 is information including the first correction angle to which the angle is corrected by the control device 1.

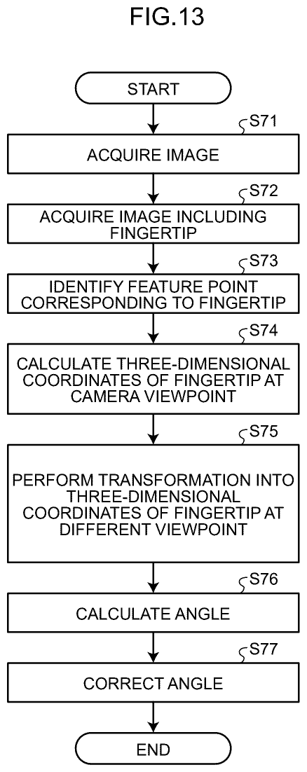

Next, a processing procedure of the control device 1 according to the second embodiment will be described with reference to FIG. 13. FIG. 13 is a flowchart illustrating a processing procedure of the control device 1 according to the second embodiment. Note that the processing from step S71 to step S76 in the flowchart illustrated in FIG. 13 is similar to the processing from step S71 to step S76 in the flowchart illustrated in FIG. 7, and thus description thereof will be omitted.

In step S77, the correction unit 16 corrects the angle calculated by the calculation unit 15 (step S77). For example, in step S77, the correction unit 16 corrects the angle calculated by the calculation unit 15 to the first correction angle according to the movement of the fingertip 72 in consideration of the depth direction of the sensor 500. When the processing of step S77 ends, this processing executed by the control device 1 ends.

The CPU may implement the correction unit 16 by executing the program store in the ROM using the RAM as a working area. This may be rephrased as the control device 1 including the correction unit 16. The correction unit 16 may be implemented by different hardware than the image acquisition unit 11, the identification unit 12, the coordinate calculation unit 13, the coordinate transformation unit 14 and the calculation unit 15.

As described above, the control device 1 according to one aspect of the present disclosure corrects the angle to the first correction angle according to the movement of the fingertip 72 in consideration of the depth direction of the sensor 500. As a result, the control device 1 can suppress an error, for example, due to a change according to a vertical movement of the user's fingertip 72. Therefore, the control device 1 can improve user operability.

### Third Modification

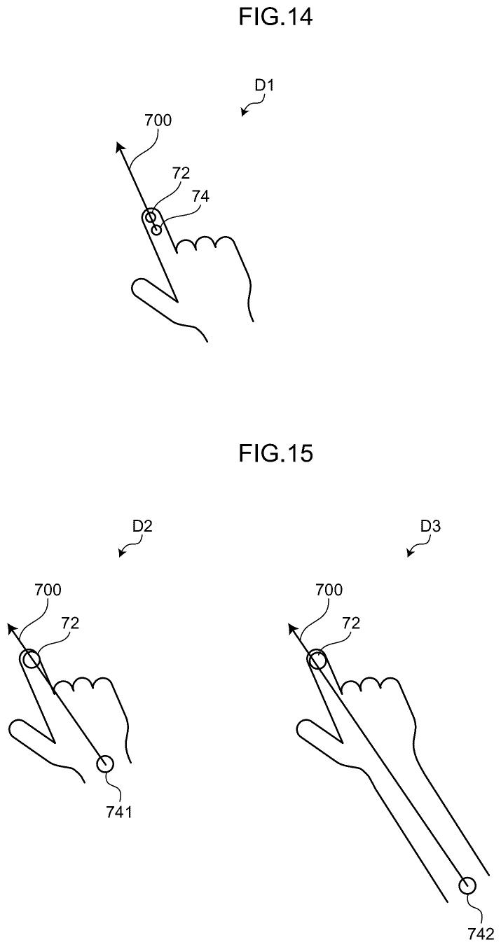

Next, the processing performed by the control device 1 to stabilize the variations in the angle calculated with respect to the user's fingertip 72 will be described. FIGS. 14 and 15 are schematic diagrams for explaining the processing of the control device 1 according to the third modification.

FIGS. 14 and 15 each illustrate a state in which the user's fingertip 72 points to the operation device 600. For example, as in a state D1 illustrated in FIG. 14, when the direction in which the user's fingertip 72 points to the target is defined as an angular line 700 connecting the fingertip 72 to a second joint 74 of the finger, if the user's movement varies greatly or if the position identified by the identification unit 12 varies greatly, the angle calculated by the control device 1 may vary greatly. That is, when the distance between the fingertip 72 and the second joint 74 of the finger is short, the angle calculated by the control device 1 may vary greatly.

Therefore, in the control device 1, the angular line 700 is arranged in such a manner that its start point and its end point are spaced far away from each other as in a state D2 and a state D3 illustrated in FIG. 15. For example, as in the state D2 illustrated in FIG. 15, the angular line 700 is arranged in such a manner that a wrist 741 is its start point and fingertip 72 is its end point. In addition, for example, as in the state D3 illustrated in FIG. 15, the angular line 700 is arranged in such a manner that an elbow 742 is its start point and the fingertip 72 is its end point.

As a result, the control device 1 can suppress variations in the calculated angle. Note that the angular line 700 is arranged in such a manner that the user's eye line is its start point and the fingertip 72 is its end point. The arrangement of the eyes may be set by, for example, fixed values of three-dimensional coordinates at the viewpoint 501 different from the viewpoint of the sensor 500.

### Third Embodiment

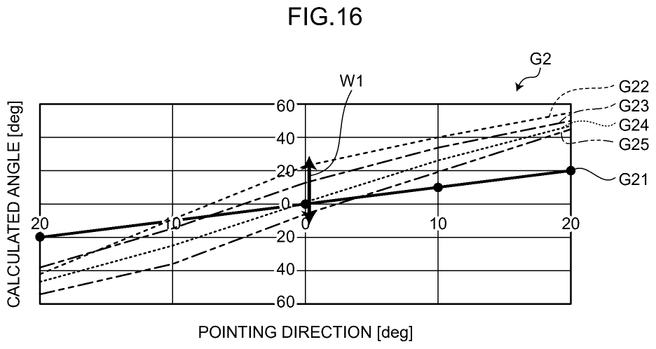

Next, in the third embodiment, processing of the control device 1 corresponding to a positional relationship between the sensor 500 and the user will be described. Here, the positional relationship between the sensor 500 and the user and the angle corresponding to the positions of the sensor 500 and the fingertip 72 calculated by the control device 1 will be described with reference to FIG. 16.

FIG. 16 is a schematic diagram for explaining processing performed by an information processing apparatus according to a second comparative example. In a schematic diagram G2 that is a graph illustrated in FIG. 16, the vertical axis represents a calculated angle (deg) calculated by the control device 1, and the horizontal axis represents a pointing direction (deg).

A graph G21 in FIG. 16 is a graph representing an ideal value when the user's fingertip 72 points in a predetermined pointing direction. The graph G21 is also referred to as a true value. A graph G22 to a graph G25 in FIG. 16 indicate results of angles calculated by the control device 1 with the user's fingertip 72 pointing in the predetermined pointing direction at positions and postures different from those in the graph G21.

When the graph G21 is compared with the graph G22 to the graph G25, the control device 1 calculates different angles. This result depends on the positional relationship between the sensor 500 and the user's fingertip 72, for example, whether the user's right hand or left hand is used to point. This is because, for example, even in a case where the user points in a pointing direction of 0 (deg), the position and posture of the hand are different, and thus, the angle 900 varies, the angle indicating an angle formed by the traveling direction M1 of the vehicle and the angular line 700 along which the user's fingertip 72 points to the target in the X-axis direction and the Y-axis direction.

In addition, the angle formed also varies due to a difference in the position of the user (for example, a seat position of the user in the vehicle) and a difference in effectiveness depending on the user as well as the movement of the user's hand. As a result, there may be a deviation between the true value and the calculated angle as in a difference W1 illustrated in FIG. 16. Therefore, the processing of the control device 1 corresponding to the positional relationship between the sensor 500 and the user according to the third embodiment will be described.

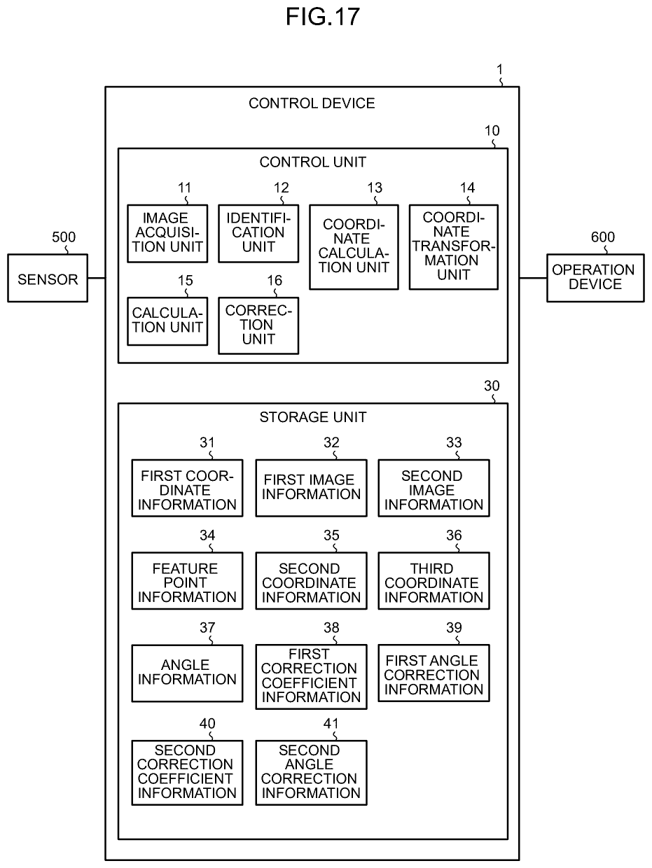

FIG. 17 is a diagram illustrating a schematic configuration of an information system including a control device 1 that is an information processing apparatus according to the third embodiment. The information processing apparatus according to the third embodiment further realizes second correction coefficient information 40 and second angle correction information 41 in the storage unit 30 of the control device 1, as compared with the information processing apparatus according to the second embodiment.

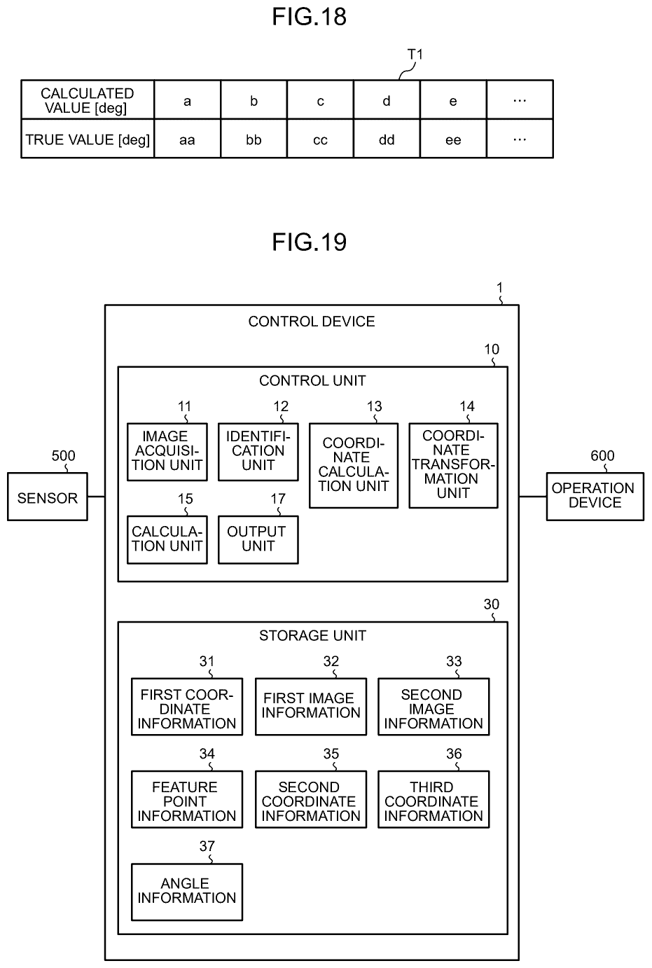

The correction unit 16 corrects the angle to a second correction angle according to the positions of the sensor 500 and the user and the positions of the sensor 500 and the fingertip 72. Specifically, the correction unit 16 corrects the angle calculated by the calculation unit 15 to the second correction angle according to the positions of the sensor 500 and the user and the positions of the sensor 500 and the fingertip 72. For example, referring to the second correction coefficient information, the correction unit 16 corrects the angle calculated by the calculation unit 15 to the second correction angle. The correction unit 16 of the third embodiment may be referred to as a second correction unit. Here, the second correction coefficient information will be described with reference to FIG. 18.

FIG. 18 is a schematic diagram illustrating an example of the second correction coefficient information according to the third embodiment. A table T1 in the schematic diagram illustrated in FIG. 18 is a table in which a calculated value calculated from an angle with the user's wrist as a start point and the user's fingertip 72 as an end point is associated with a true value of a direction in which the user's fingertip 72 actually points to the target. The correspondence relationship between the calculated value and the true value shown in the table T1 can be derived, for example, from the relationship of calculated value=approximate expression (true value) and true value=inverse function (calculated value).

For example, referring to the table T1 illustrated in FIG. 18, the correction unit 16 associates the angle calculated by the calculation unit 15 with the calculated value illustrated in the table T1, and corrects the associated calculated value illustrated in the table T1 to the true value illustrated in the table T1, thereby correcting the angle calculated by the calculation unit 15 to the second correction angle. As a result, the control device 1 can suppress an error due to a change according to a positional relationship between the sensor 500 and the user.

Referring back to FIG. 17, the description will be continued. The second correction coefficient information 40 is information indicated in the above-described table T1 in which a calculated value calculated from an angle with the user's wrist as a start point and the user's fingertip 72 as an end point and a true value of a direction in which the user's fingertip 72 actually points to the target are associated with each other.

The CPU may implement the correction unit 16 by executing the program store in the ROM using the RAM as a working area. This may be rephrased as the control device 1 including the second correction unit. The correction unit 16 may be implemented by different hardware than the image acquisition unit 11, the identification unit 12, the coordinate calculation unit 13, the coordinate transformation unit 14 and the calculation unit 15.

As described above, the control device 1 according to one aspect of the present disclosure corrects the angle to the second correction angle according to the positions of the sensor 500 and the user and the positions of the sensor 500 and the fingertip 72. As a result, the control device 1 can suppress an error due to a change according to a positional relationship between the sensor 500 and the user. Therefore, the control device 1 can improve user operability.

### Fourth Modification

In the third embodiment described above, a mode in which, referring to the second correction coefficient information, the control device 1 corrects the calculated angle to the second correction angle has been described. In the fourth modification, a mode in which, referring to position information of the user, the correction unit 16 corrects the calculated angle to the second correction angle will be described. Here, the position information of the user is information based on the positions of the sensor 500 and the user.

For example, referring to the position information of the user, the correction unit 16 corrects the angle calculated by the calculation unit 15 to the second correction angle aligned with the center position of the user. Here, the alignment with the center position of the user refers to, for example, moving the coordinates of the sensor 500 on the X axis to the coordinates of the user on the X axis. That is, the viewpoint of the sensor 500 is a viewpoint when the user is viewed from directly above the vehicle.

For example, the correction unit 16 identifies the center position of the user from an image acquired by the image acquisition unit 11. Note that, for example, the correction unit 16 may identify the positions of the user's right and left hands from the image acquired by the image acquisition unit 11. Note that the correction unit 16 may identify the center position of the user, for example, from a time of flight (TOF) sensor mounted on the vehicle.

Note that, for example, the correction unit 16 may perform calibration while changing the correction value for each user, or may change the correction value for each of the user's right and left hands, in addition to the alignment with the center position of the user. In addition, the correction value is not limited to a predetermined fixed value, and may be variable using, for example, hand position information detected by artificial intelligence (AI), a TOF sensor, or the like. As a result, the control device 1 can suppress an error due to a change according to a positional relationship between the sensor 500 and the user by correcting the calculated angle based on the position of the user. Therefore, the control device 1 can improve user operability.

### Fifth Modification

For example, depending on the direction of the sensor 500 and the direction of the hand, an occlusion indicating an event in which the user's finger is hidden may occur. In this case, the control device 1 may not be able to calculate an angle at which the user's fingertip 72 points to the target, or the calculated angle may vary greatly.

Therefore, when the identification unit 12 of the control unit 10 of the control device 1 according to the fifth modification is not able to identify feature points corresponding to the fingertip 72 from the image including the fingertip 72 with which the user points to the target, the identification unit 12 may identify feature points of the user's body from the image acquired by the image acquisition unit 11, in which the user is imaged, and the coordinate calculation unit 13 may calculate three-dimensional coordinates of the fingertip 72 at the camera viewpoint based on feature points corresponding to the joints of the user's hand and the user's wrist corresponding to the feature points of the user's body identified by the identification unit 12.

### Fourth Embodiment

For example, a user who points to an object outside the vehicle may want to grasp whether the position pointed to by the user matches angle information calculated by the control device 1. Therefore, in the fourth embodiment, a mode in which the angle calculated by the control device 1 is output will be described.

FIG. 19 is a diagram illustrating a schematic configuration of an information system including a control device 1 that is an information processing apparatus according to the fourth embodiment. The information processing apparatus according to the fourth embodiment further realizes an output unit 17 of the control unit 10 of the control device 1, as compared with the information processing apparatus according to the first embodiment. The output unit 17 outputs angle-related information indicating information related to an angle. Specifically, the output unit 17 outputs angle-related information indicating information related to an angle at which the fingertip 72 points to the target, the angle being calculated by the calculation unit 15.

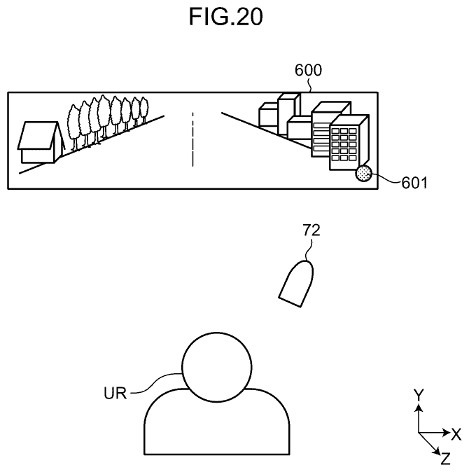

FIG. 20 is a schematic diagram for explaining processing performed by an information processing apparatus according to the fourth embodiment. FIG. 20 illustrates a user UR, a fingertip 72 of the user UR, and an operation device 600. In addition, FIG. 20 illustrates angle-related information 601 output to the operation device 600 by the output unit 17 of the control unit 10 of the control device 1 regarding the angle calculated by the calculation unit 15.

In a case where the operation device 600 is a navigation device, the angle-related information 601 is, for example, in a form in which a target pointed to by the user is displayed as a marker on a map displayed on the navigation device. In addition, in a case where the operation device 600 is a display mounted on a windshield of the vehicle, the angle-related information 601 may be, for example, in a form in which a target pointed to by the user is displayed as a marker on the display using an augmented reality (AR) technology or the like.

Furthermore, in a case where the operation device 600 is a light control panel mounted on the windshield of the vehicle, the angle-related information 601 may be, for example, in a form in which light is adjusted at a portion pointed to by the user. In the case where the operation device 600 is a light control panel mounted on the windshield of the vehicle, a portion that is not pointed to by the user becomes transparent, so that the user's field of view becomes good. Further, the angle-related information 601 may be in a form in which light is emitted from a light emitting unit in a direction pointed to by the user, for example, using a light emitting diode (LED) or the like mounted on the vehicle. As a result, when the operator actually points to the operation device 600, the operator can grasp which position of the operation device 600 is pointed to by the operator itself.

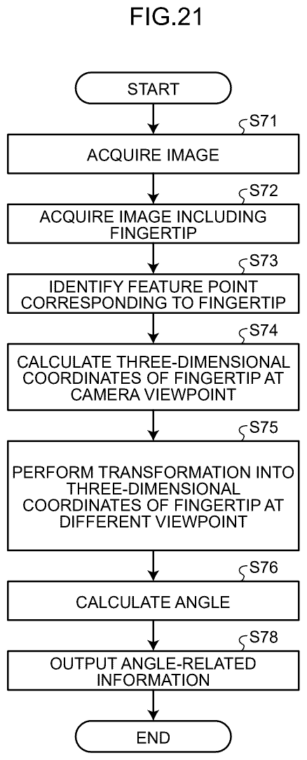

Next, a processing procedure of the control device 1 according to the fourth embodiment will be described with reference to FIG. 21. Note that the processing from step S71 to step S76 in the flowchart illustrated in FIG. 21 is similar to the processing from step S71 to step S76 in the flowchart illustrated in FIG. 7, and thus description thereof will be omitted.

In step S78, the output unit 17 outputs angle-related information indicating information related to an angle at which the fingertip 72 points to the target, the angle being calculated by the calculation unit 15. When the processing of step S78 ends, this processing executed by the control device 1 ends.

The CPU may implement the output unit 17 by executing the program store in the ROM using the RAM as a working area. This may be rephrased as the control device 1 including the output unit 17. The output unit 17 may be implemented by different hardware than the image acquisition unit 11, the identification unit 12, the coordinate calculation unit 13, the coordinate transformation unit 14 and the calculation unit 15.

As described above, the control device 1 according to one aspect of the present disclosure outputs angle-related information indicating information related to an angle at which the fingertip 72 points to the target. As a result, for example, the user can grasp whether the angle information calculated by the control device 1 is correct when pointing to an object outside the vehicle. Therefore, the control device 1 can improve user operability.

### Sixth Modification

The output unit 17 of the control unit 10 of the control device 1 according to the fourth embodiment described above may output the first angle corrected by the correction unit 16 according to the second embodiment and the second angle corrected by the correction unit 16 according to the third embodiment to the operation device 600. As a result, for example, the user can grasp whether the angle information calculated by the control device 1 is correct when pointing to an object outside the vehicle.

Although the embodiments of the present disclosure have been described above, the above-described embodiments are exemplary, and are not intended to limit the scope of the invention. These novel embodiments can be implemented in various other forms, and various omissions, substitutions, and changes can be made without departing from the gist of the invention. These novel embodiments and modifications thereof fall within the scope and spirit of the invention, and fall within the invention set forth in the claims and the equivalent scope thereof. Furthermore, constituent elements in different embodiments and modifications may be appropriately combined.

In addition, in the above-described embodiments, the notation “ . . . section” may be replaced with another notation such as “ . . . circuitry”, “ . . . assembly”, “ . . . device”, “ . . . unit”, or “ . . . module”.

In each of the above-described embodiments, the present disclosure has been described using an example in which the present disclosure is realized by hardware, but the present disclosure can also be realized by software in cooperation with hardware.

Each functional block used in describing each embodiment above is typically realized as an LSI that is an integrated circuit. The integrated circuit may control each functional block used in describing each embodiment above, and include an input terminal and an output terminal. These functional blocks may be implemented as individual chips, or some or all of the functional blocks may be included in a single chip. Although each functional block is referred to as an LSI herein, it may also be referred to as an IC, a system LSI, a super LSI, or an ultra LSI depending on the level of integration.

In addition, the circuit integration method is not limited to LSI, and may be realized using a dedicated circuit or a general-purpose processor and a memory. A field programmable gate array (FPGA) that can be programmed after the LSI is manufactured or a reconfigurable processor that can reconfigure the connections or settings of circuit cells inside the LSI may be used.

Furthermore, if an integrated circuit technique that can replace the LSI appears due to advances in the semiconductor technology or another derived technology, the functional blocks may be integrated using that technique. Biotechnology and the like may be applied.

The information processing apparatus according to the present disclosure is capable of improving user operability. Note that the effects described herein are not necessarily limited, and may be any of the effects described in the present specification.

While certain embodiments have been described, these embodiments have been presented by way of example only, and are not intended to limit the scope of the inventions.

Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

### Supplemental Notes

The following Techniques are disclosed by the above description of the embodiments.

### Technique 1

An information processing apparatus comprising:
an image acquisition unit that acquires an image captured by a camera and including a fingertip with which a user points to a target;
a coordinate calculation unit that calculates three-dimensional coordinates of the fingertip at a camera viewpoint from the image;
a coordinate transformation unit that transforms the three-dimensional coordinates of the fingertip at the camera viewpoint into three-dimensional coordinates of the fingertip at a viewpoint different from the camera viewpoint; and
a calculation unit that calculates an angle at which the fingertip points to the target, based on two-dimensional coordinates of the fingertip excluding a depth direction identified from the three-dimensional coordinates of the fingertip at the different viewpoint.

### Technique 2

The information processing apparatus according to technique 1, further comprising:
a correction unit that corrects the angle to a first correction angle according to a movement of the fingertip in consideration of the depth direction.

### Technique 3

The information processing apparatus according to technique 1, further comprising:
a second correction unit that corrects the angle to a second correction angle according to positions of the camera and the user and positions of the camera and the fingertip.

### Technique 4

The information processing apparatus according to any one of techniques 1 to 3, further comprising:
an output unit that outputs angle-related information indicating information related to the angle.

### Technique 5

An information processing system comprising a camera and an information processing apparatus, wherein
the camera is configured to capture an image of a user who is an operator, and
the information processing apparatus includes:
   an image acquisition unit that acquires an image captured by the camera and including a fingertip with which the user points to a target;
   a coordinate calculation unit that calculates three-dimensional coordinates of the fingertip at a camera viewpoint from the image;
   a coordinate transformation unit that transforms the three-dimensional coordinates of the fingertip at the camera viewpoint into three-dimensional coordinates of the fingertip at a viewpoint different from the camera viewpoint; and
   a calculation unit that calculates an angle at which the fingertip points to the target based on two-dimensional coordinates of the fingertip excluding a depth direction identified from the three-dimensional coordinates of the fingertip at the different viewpoint.

### Technique 6

An information processing method executed by an information processing apparatus, the information processing method comprising:
an image acquisition step of acquiring an image captured by a camera and including a fingertip with which a user points to a target;
a coordinate calculation step of calculating three-dimensional coordinates of the fingertip at a camera viewpoint from the image;
a coordinate transformation step of transforming the three-dimensional coordinates of the fingertip at the camera viewpoint into three-dimensional coordinates of the fingertip at a viewpoint different from the camera viewpoint; and
a calculation step of calculating an angle at which the fingertip points to the target, based on two-dimensional coordinates of the fingertip excluding a depth direction identified from the three-dimensional coordinates of the fingertip at the different viewpoint.

### Technique 7

An information processing program causing a computer to perform:
an image acquisition step of acquiring an image captured by a camera and including a fingertip with which a user points to a target;
a coordinate calculation step of calculating three-dimensional coordinates of the fingertip at a camera viewpoint from the image;
a coordinate transformation step of transforming the three-dimensional coordinates of the fingertip at the camera viewpoint into three-dimensional coordinates of the fingertip at a viewpoint different from the camera viewpoint; and
a calculation step of calculating an angle at which the fingertip points to the target, based on two-dimensional coordinates of the fingertip excluding a depth direction identified from the three-dimensional coordinates of the fingertip at the different viewpoint.

What is claimed is:

1. An information processing apparatus comprising:
a memory in which a program is stored; and
a processor coupled to the memory and configured to perform processing by executing the program, the processing including:
acquiring an image captured by a camera and including a fingertip with which a user points to a target;
calculating three-dimensional coordinates of the fingertip at a camera viewpoint from the image;
transforming the three-dimensional coordinates of the fingertip at the camera viewpoint into three-dimensional coordinates of the fingertip at a viewpoint different from the camera viewpoint; and
calculating an angle at which the fingertip points to the target, based on two-dimensional coordinates of the fingertip excluding a depth direction identified from the three-dimensional coordinates of the fingertip at the different viewpoint.

2. The information processing apparatus according to claim 1, wherein the processing further including correcting the angle to a first correction angle according to a movement of the fingertip in consideration of the depth direction.

3. The information processing apparatus according to claim 1, wherein the processing further including correcting the angle to a second correction angle according to positions of the camera and the user and positions of the camera and the fingertip.

4. The information processing apparatus according to claim 1, wherein the processing further including outputting angle-related information indicating information related to the angle.

5. The information processing apparatus according to claim 1, wherein the target includes an operation device and an object outside a vehicle.

6. The information processing apparatus according to claim 1, wherein the camera is mounted on a vehicle.

7. The information processing apparatus according to claim 1, wherein the angle is an angle of a straight line connecting the fingertip and a wrist of the user.

8. The information processing apparatus according to claim 1, wherein the depth direction is a direction connecting a camera and a position of the fingertip.

9. The information processing apparatus according to claim 1, wherein the different viewpoint is a viewpoint when the fingertip is viewed from directly above.

10. The information processing apparatus according to claim 1, wherein the camera is configured to capture an image of the user who is an operator.

11. An information processing method executed by an information processing apparatus, the information processing method comprising:
acquiring an image captured by a camera and including a fingertip with which a user points to a target;
calculating three-dimensional coordinates of the fingertip at a camera viewpoint from the image;
transforming the three-dimensional coordinates of the fingertip at the camera viewpoint into three-dimensional coordinates of the fingertip at a viewpoint different from the camera viewpoint; and
calculating an angle at which the fingertip points to the target, based on two-dimensional coordinates of the fingertip excluding a depth direction identified from the three-dimensional coordinates of the fingertip at the different viewpoint.

12. A non-transitory computer-readable medium including programmed instructions that cause a computer to perform:
acquiring an image captured by a camera and including a fingertip with which a user points to a target;
calculating three-dimensional coordinates of the fingertip at a camera viewpoint from the image;
transforming the three-dimensional coordinates of the fingertip at the camera viewpoint into three-dimensional coordinates of the fingertip at a viewpoint different from the camera viewpoint; and
calculating an angle at which the fingertip points to the target, based on two-dimensional coordinates of the fingertip excluding a depth direction identified from the three-dimensional coordinates of the fingertip at the different viewpoint.
